(19) United States
(12) Patent Application Publication
(10) Pub. No.: US 2014/0137190 A1
(43) Pub. Date: May 15, 2014

(54) METHODS AND SYSTEMS FOR PASSIVELY DETECTING SECURITY LEVELS IN CLIENT DEVICES

(71) Applicant: RAPID7, INC., Boston, MA (US)

(72) Inventors: Marcus J. Carey, Round Rock, TX (US); Johann Christian Felix Kirsch, Somerville, MA (US); HD Moore, Austin, TX (US)

(73) Assignee: RAPID7, INC., Boston, MA (US)

(21) Appl. No.: 13/771,943

(22) Filed: Feb. 20, 2013

Related U.S. Application Data
(60) Provisional application No. 61/724,406, filed on Nov. 9, 2012.

(51) Int. Cl. H04L 29/06; G06F 21/57

(52) U.S. Cl. CPC H04L 63/10; G06F 21/577
USPC 726/3; 726/25

(57) ABSTRACT

Embodiments of the present teachings relate to systems and methods for testing and analyzing the security of a target computing device. The method can include providing, to a server via a network, a security tool operable to be associated with a webpage accessible by a target computing device through the server, wherein security tool is operable to be executable by the target computing device and operable to collect one or more security metrics of the target computing device; receiving, from the server, the one or more security metrics of the target computing device; comparing the one or more security metrics with a security vulnerability database; and determining a level of security vulnerability for the target computing device based on comparing the one or more security metrics with the security vulnerability database.

### CROSS-REFERENCE TO RELATED APPLICATIONS

This application claims the benefit of U.S. Provisional Application No. 61/724,406, filed Nov. 9, 2012, which is herein incorporated by reference in its entirety.

### FIELD

Aspects of the disclosure relate generally to computer security.

### DESCRIPTION OF THE RELATED ART

Increasingly organizations are allowing employees to bring their personally owned mobile device to their places of work and use those devices to access privileged organization (e.g., company) resources such as email, file servers, and databases, as well as their own personal applications and data. This organization or business policy is known as bring you own device (BYOD), bring your own technology (BYOT), or more broadly as bring your own behavior (BYOB), which includes the hardware device(s), but also the software used on the device(s) (e.g., web browsers, media players, antivirus software, word processors, etc.).

This trend often leaves users and the organization to which they are associated at odds. Users like the benefit of choosing and using their own devices. On the other hand, organizations, and especially administration personal whose job it is to manage network resources of the organization, tend not to be as enthusiastic with this behavior. This is because they can no longer retain the control they once had when they were able to control which device were used and how those devices interacted with the network resources. As a consequence of this behavior, organizations and administers tend to have difficulty keeping the devices managed and updated with the latest hardware and/or software updates. Also, organizations may not even know which devices exist on the network, let alone the level of security of those devices. This policy can provide a window for malicious entities to attack device that have not been managed or updated with the most current software, as well as other devices and/or network resources of the organization. For example, the malicious entities can plant viruses, Trojans, or other malicious agents in publicly available content in order to attack the devices and/or networks of the employee and/or the organization and steal sensitive information from the users.

To prevent attacks on computing systems, the administrators and owners of computing systems desire to identify possible security threats before they can be attacked by malicious entities. This, however, can be a difficult task. Often, the administrator must individually examine each computing system to identify possible weaknesses. The administrators can utilize tools to remotely examine the computing system, for example. These tools, however, lack flexibility in examining the computing systems and, often, specialized routines and custom application programs must be developed for each specific computing system. Moreover, attackers have moved from attacking servers to client machines. One major attack vector can be to exploit machines through the browser through phishing emails containing links to malicious websites or malicious attachments. What is needed is an improved mechanism whereby client devices can be examined for potential security vulnerabilities.

### SUMMARY

According to aspects of the present disclosure, a method for security testing is disclosed. The method can comprise providing, to a server via a network, a security tool operable to be associated with a webpage accessible by a target computing device through the server, wherein security tool is operable to be executable by the target computer device and operable to collect one or more security metrics of the target computer device; receiving, from the server, the one or more security metrics of the target computing device; comparing the one or more security metrics with a security vulnerability database; and determining a level of security vulnerability for the target computing device based on comparing the one or more security metrics with the security vulnerability database.

According to aspects, the method can include providing the level of security vulnerability to the server.

According to aspects, the server can include functionality of a web server.

According to aspects, the method can include updating the security vulnerability database; and comparing the one or more security metrics with the updated security vulnerability database; and determining a new level of security vulnerability for the target computing device based on comparing the one or more security metrics with the updated security vulnerability database.

According to aspects, the one or more security metrics can include information related to a software, a hardware, or both a software and hardware configuration of the target computer device.

According to aspects, the security tool can be operable to be embedded into a webpage provided by the server and accessible by the target computer device and activated by the target computing device if the webpage is accessed by the target computer device.

According to aspects, the information can include one or more of the following: operating system type, operating system version, operating system version update status, browser type, browser version, browser version update status, browser plug-in type, browser plug-in version, browser plug-in version update status, and combinations thereof.

According to aspects, the method can include comparing each item of the information with a current security database for each item of the information on the target computer device; determining a security vulnerability score for the target computer device; comparing the security vulnerability score with a predetermined security vulnerability score threshold; and determining access ability of the target computer device to the server.

According to aspects, the method can include restricting access to the server if the security vulnerability score is less than the predetermined security vulnerability score threshold by redirecting the target computer device to another web page.

According to aspects, the method can include restricting access to the server if the security vulnerability score is less than the predetermined security vulnerability score threshold by providing an overlay on a screen of the target computer device such that the user of the target computer device cannot access the server.

According to aspects of the present disclosure, a method for security testing a target computing system using a security tool from a security server is disclosed. The method can include receiving, at a web server from the security server via a network, the security tool operable to be executable by the target computer device and operable to collect one or more security metrics of the target computer device; associating the security tool with a webpage that is operable to be accessible by the target computing device; providing the webpage with the security tool to the target computing device; receiving the one or more security metrics of the target computing device; providing the one or more security metrics to the server to determine a level of security vulnerability for the target computing device.

According to aspects, the method can further include receiving the level of security vulnerability from the security server; and providing the level of security vulnerability to the target computing device.

According to aspects, the server can include the functionality of a web server.

According to aspects, the security tool can be operable to collect one or more security metrics from the target computing device, wherein the one or more security metrics comprise information related to a software, a hardware, or both a software and hardware configuration of the target computer device.

According to aspects, the method can include embedding the security tool into a webpage provided by the intranet server and which is accessible by the target computer device and activated if the webpage is accessed by the target computer device.

According to aspects, the one or more security metrics can include information comprises one or more of the following: operating system type, operating system version, operating system version update status, browser type, browser version, browser version update status, browser plug-in type, browser plug-in version, browser plug-in version update status, and combinations thereof.

According to aspects, the method can include receiving, from the security server, a security vulnerability score for the target computing device; providing access ability of the target computer device based on the security vulnerability score.

According to aspects, the method can include restricting access to resources provided by the intranet server if the security vulnerability score is less than the predetermined security vulnerability score threshold by redirecting the target computing device to another web page.

According to aspects, the method can include restricting access to resources provided by the intranet server if the security vulnerability score is less than the predetermined security vulnerability score threshold by providing an overlay on a screen of the target computing device such that the user of the target computing device cannot access the resources.

According to aspects of the present disclosure, a device is disclosed that can include one or more processors; and a computer readable medium comprising instructions that cause the one or more processors to perform a method comprising: providing, to a server via a network, a security tool operable to be associated with a webpage accessible by a target computing device through the server, wherein security tool is operable to be executable by the target computing device and operable to collect one or more security metrics of the target computing device; receiving, from the server, the one or more security metrics of the target computing device; comparing the one or more security metrics with a security vulnerability database; and determining a level of security vulnerability for the target computing device based on comparing the one or more security metrics with the security vulnerability database.

According to aspects of the present disclosure, a device operable to provide security testing of a target computing system using a security tool from a security server is disclosed. The device can include one or more processors; and a computer readable medium comprising instructions that cause the one or more processors to perform a method comprising: receiving, at an intranet server from the security server via a network, the security tool operable to be executable by the target computing device and operable to collect one or more security metrics of the target computing device; associating the security tool with a webpage that is operable to be accessible by the target computing device; providing the webpage with the security tool to the target computing device; receiving the one or more security metrics of the target computing device; providing the one or more security metrics to the server to determine a level of security vulnerability for the target computing device.

According to aspects of the present disclosure, a security tool, embodied in a non-transitory computer readable medium, is disclosed. The security tool is operable to be associated, or embedded, with a webpage. The security tool is operable to be executed by a target computing device when the target computing device opens the webpage with the associated security tool. The security tool is operable to be collect information on the target computing device and determine a security vulnerability score, based on a security vulnerability database. The information collected by the security tool can include information related to any, or combinations of, a hardware, a software, a firmware profile of the target computing device. The information can be compared with the security vulnerability database and a composite security score can be computed. The composite security score can be used to control the target computing device ability to access information within a particular computer network. If the composite security score is computed to be below a predetermined threshold, the user of the target computing device may be redirected to another webpage or presented with an overlay over the screen of the target computing device to prevent the user from seeing, accessing, or using the underlying data. Also, the user may be presented with information to update the target computing device so that the target computing device would have a security score above the predetermined threshold score.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 is block diagram of an exemplary environment in which a security tool can test and analyze computing systems, according to various embodiments.

FIG. 2 is a flow diagram of exemplary processes performed by a security server, according to various embodiments.

FIG. 3 is a flow diagram of exemplary processes performed by a web server, according to various embodiments.

FIG. 4 is a block diagram of an exemplary computing system, according to various embodiments.

### DETAILED DESCRIPTION

For simplicity and illustrative purposes, the principles of the present teachings are described by referring mainly to exemplary embodiments thereof. However, one of ordinary skill in the art would readily recognize that the same principles are equally applicable to, and can be implemented in, all types of information and systems, and that any such variations do not depart from the true spirit and scope of the present teachings. Moreover, in the following detailed description, references are made to the accompanying figures, which illustrate specific exemplary embodiments. Electrical, mechanical, logical and structural changes may be made to the exemplary embodiments without departing from the spirit and scope of the present teachings. The following detailed description is, therefore, not to be taken in a limiting sense and the scope of the present teachings is defined by the appended claims and their equivalents.

Embodiments of the present teachings relate to systems and methods for testing and analyzing the security of a network of computing systems. In particular, a security tool can be used gather, analyze, and determine a security level of a computing device (target computing device) including determining a security level that may indicate if the target computing device is vulnerable or potentially vulnerable to one or more security threats. The target computing device can include both BYOD-type computing devices, as well as, computing devices that are actively managed by the organization. The target computing device can include desktops, laptops, tablets, and other personal computing devices, such as smart phones. The security tool can be provided by a trusted source, including, but to limited to a security server or web server. The security server or the web server can be operated, hosted, or maintained by an organization or affiliated entity with the organization that wishes to maintain a desired level of security for devices operating on the network. The security tool can include one or more algorithms provided to the target computing device by one of the servers. The one or more algorithms can be embedded in a website that the user of the target computing device typically views, such that the process of gathering, analyzing, and determining security level can be transparent to the user. For example, the website can be a website that is only accessible to user within the organization such as a website on an internal network of the organization. The website can be hosted by an internal webserver or can be provided as a software as a service (SaaS), where software and associated data are centrally hosted on a cloud-based environment. The website can require a login and is only available to users within the organization. Because the security tool is provided in a manner that can be transparent to the user, the user experience can be seamless by not needing the user to click on any links or activate any scan buttons. Moreover, administrators associated with the organization will not have to deploy software to their computing devices or ask their users to do the same to have their computing devices analyzed to determine the security level.

In implementations, security tool can be operable to collect information on the target computing device. The information collected can include information related to a software configuration, a hardware configuration, or both a software and a hardware configuration of the target computing device. The information can then be used to determine the security level, which can indicate whether the target computing device may be susceptible attacks and how severe these vulnerabilities are. The security tool can be delivered to the target computing device in a manner that is undetectable or unnoticeable to the user, or does not require any user interaction on the target computing device.

In implementations, users of BYOD devices (target computing device) can access an internal Intranet page containing a security tool from a security server. The security tool can be added to any web server to enable, browser risk management and/or vulnerability analytics to restrict access to organization resources, including access to particular web pages or other network resources. Through the security tool, the security server can record information about the target computing device, including browser and plug-in information, and can correlate this information with existing vulnerability information for these software versions to assess the security risk level of the target computing device. The security tool can also be operable to perform active probing of the security of the target computing device, e.g., testing egress filtering, firewall rules, and anti-virus software. Additionally and/or alternatively, the security tool can install software on the target computing device that can be used on the target computing device to collect additional information about the target computing device, including information that can be used to identify the target computing device and information that can be used to identify a user of the target computing device.

Based on the information collected, the security tool and/or the security server can be operable to determine a trust score for the target computing device. If the target computing device does not achieve a minimum trust score, the security tool can be operable to redirect the user of the target computing device to a different web page and/or restrict access to the web server. The security server can also be operable to restrict access to the website based on the fact that no security software has been installed on the target computing device.

The security tool can be configure as software that can be embedded within a web page that can scan to determine a security level by scanning for vulnerabilities on the target computing device, wherein the vulnerabilities can include, but not limited to browsers and browser plugins. The security tool can be visible or transparent to the user and can be operable to provide feedback to the user on whether the target computing device is secure and/or may be vulnerable. The security tool can also provide remediation advice, including providing information on how to update the target computing device, and can block the user from accessing the website. The security tool can be operable to discover devices connecting to websites so their security level can be audited later, for example with a vulnerability scanner or penetration testing tool. The security tool can be operable to read/process the currently logged in user and report and/or act on the security details of the user, reporting both vulnerabilities and the user name to a backend. The security tool can be operable to refuse access to the website unless a piece of software, for example a browser plugin, is present on the target computing device that assures the security level of the target computing device. The security tool can be operable to use software on the target computing device, for example, a plugin, to perform the following actions: determine the identity of the currently logged on user and/or, block access to the website if the plugin is not installed or if the target computing device does not meet basic security requirements (e.g. browser and plugin patch levels, firewall settings, antivirus setting in the case that the target computing device was determined to be insecure. For example, if the security tool, such as a Javascript or similar scripting software language or programming language, determines that the target computing device does not have a software plugin installed, such as a browser plugin, the security tool can be operable to restrict access to a requested web page. The security tool can alert the user that the security level of the target computing device does not meet a minimum level of security and restrict access to web pages by creating a window overlay on the screen of the target device to prevent the user from accessing the requested web page. Alternatively, the security tool can alert the user that the security level of the target computing device does not meet a minimum level of security and prompt the user to update the web browser by redirecting the user to another web page. The security tool can be embedded into any web page, including web pages of the organization and any third-party web page. For example, the software tool can be embodied as software code that can be added to any software code for any web page.

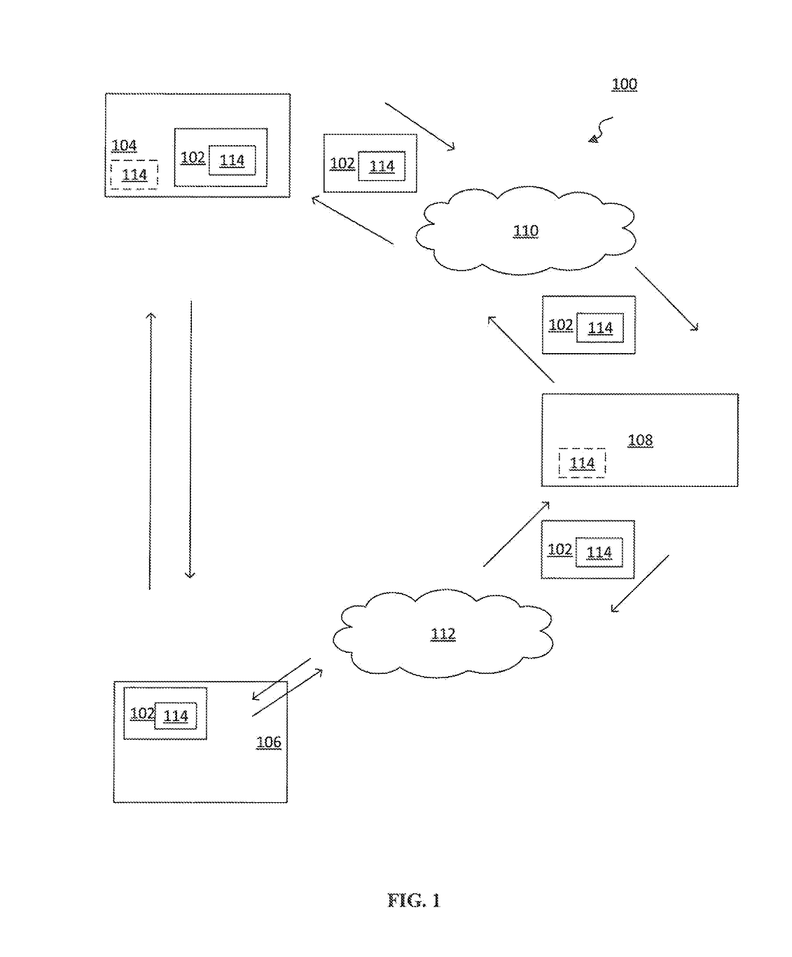

FIG. 1 illustrates an exemplary environment 100 in which security tool 102 on security server 104 can collect information to be used to analyze the security of target computing system 106. While FIG. 1 illustrates various systems contained in the environment 100, one skilled in the art will realize that these systems are exemplary and that the environment 100 can include any number and type of systems.

As illustrated in FIG. 1, security server 104 can represent the system of public or private entities, such as governmental agencies, individuals, businesses, partnerships, companies, corporations, etc., utilized to support the entities. Security server 104 can be an on-premise or remotely connected device to a network of the organization. Security server 104 can also be centrally located on-premise or remotely located and can be a distributed computer system having physical or logical structures separately located and connected to or coupled with each other through one or more communication networks. Target computing device 106 can be any type of conventional computing system, such as desktop, laptop, smart phone, or any other computing device that is or is not actively managed by the organization that security server 104 supports. Target computing device 106 can include hardware resources, such as processors, memory, network hardware, storage devices, and the like, and software resources, such as operating systems (OS), application programs, and the like. In particular, target computing device 106 can include a physical memory, such as random access memory (RAM).

The environment 100 can also include server 108 that is operable to be in communication with both security server 104 and target computing device 106. Server 108 can be an on-premise central or distributed server of the organization and can be operable to function as a web server. Server 108 can be any type of conventional computing system, such as desktop, laptop, server, etc., and can include hardware resources, such as processors, memory, network hardware, storage devices, and the like, and software resources, such as OS, application programs, and the like. Target computing device 106 and server 108 can be coupled to one or more networks 112. Security server 104 and server 108 can be coupled to one or more networks 110. The one or more networks 110 and 112 can be any type of communications networks, whether wired or wireless, to allow the computing system to communicate, such as wide-area networks or local-area networks.

In embodiments, the owners, administrators, and users of the target computing device 106 and/or server 108 desire to test and analyze the security of target computing device 106 utilizing security tool 102. Security tool 102 can be configured to provide tools to test and analyze the security of target computing device 106. Security tool 102 can be configured to be delivered to target computing device 106 from security server 104 by way of server 108. Security tool 102 can be provided to server 108 over one or more networks 110. Server 108 can then associate security tool 102 with a webpage that is accessible by target computing device 106. For example, server 108 can embed security tool 102 into the webpage in a manner such that the user of target computing device 106 is unaware that security tool 102 has been embedded. Security tool 102 can be operable, when executed by target computing device 104, to collect information on target computing device to determine a security level and/or any potential security vulnerabilities that may exist for target computing device 106. The information can include information related to a type and/or version of a software or hardware configuration on target computing device 106.

Once the information is collected, the information can be communicated to server 108 over one or more networks 112 and then from server 108 to security server 104 over one or more networks 110. Security server 104 can then analyze the information collected from target computing device 106 to determine a security level of target computing device 106 and/or whether the particular hardware and/or software configuration of target computing device 106 has any known and/or exploitable security vulnerabilities. Security server 104 can then compute a security level for target computing device 106, which can be communicated to server 108 over one or more networks 110. Security server 104 and/or server 108 can restrict access to the web pages of the organization for target computing device 106 based on the security level.

In implementations, server 104, server 108, and/or security tool 102 can be operable to record IP addresses of devices connected to server 104 and/or server 108 to perform on-demand scanning. For example, once the IP address of target computing device 106 is detected, security scanning can begin by transmitting security tool 102 to target computing device 106 via server 104 and/or server 108.

In embodiments, the security tool 102 can be configured as an application program that is capable of being stored on and executed by the computing systems of the environment 100, such as security server 104, server 108, and target computing device 106. For example, security tool 102 can be an application program written in a variety of programming languages, such as JavaScript, Ruby, JAVA, C, C++, Python code, Visual Basic, hypertext markup language (HTML), extensible markup language (XML), and the like to accommodate a variety of operating systems, computing system architectures, etc.

In embodiments, the security tool 102 can be configured to collect information on target computing device 106, which could be used to determine a security level of target computing device 106. A security vulnerability, which can be used to determine the security level, can be any type of weakness, bug, and/or glitch in the software resources and/or hardware resources of target computing device 106 that can allow the security of target computing device 106, server 108, and/or any network resources connected to or coupled with server 108 to be compromised. For example, a security vulnerability in the software resources can include, for example, software that is out of date, software that has known security weakness, configurations of software that have known security weaknesses, known bugs of software, known default credentials, etc. Likewise, a security vulnerability in the hardware resources can include, for example, known bugs in hardware, configurations of hardware that have known security weaknesses, default credentials, etc.

To determine the security level, security tool 102 can be configured to examine target computing device 106 to identify the software resources and the hardware resources of target computing device 106 and to scan for security vulnerabilities. For example, security tool 102 can be configured to scan target computing device 106 in order to identify the details of the software resources of the computing systems (type of software installed, e.g. OS and application programs, version of the software installed, configuration of the software installed, etc.) and the details of the hardware resources (type of hardware, configuration of the hardware, etc.).

Once the software and hardware resources are identified, security tool 102 can be configured to collect and/or compare the details of the software resources and the details of the hardware resources to security vulnerability database 114. Security vulnerability database 114 can be configured to store a record of known vulnerabilities for various types of known software resources and hardware resources. Security tool 102 can be configured to compare the identified details of the software resources and hardware resources of target computing device 106 to security vulnerability database 116 in order to identify security vulnerabilities in target computing device 106. Likewise, security tool 102 can be configured to specifically scan target computing device 106 for one or more of the security vulnerabilities stored in security vulnerability database 114. Security vulnerability database 114 can be configured according to any type of proprietary and/or open-source database format or scheme. In implementations, security vulnerability database 114 can be associated and communicated with security tool 102. In implementations, security vulnerability database 114 can be associated with security server 104 and/or server 108, indicated by the dotted box in FIG. 1.

In particular, security tool 102 can be configured to perform security testing on target computing device 106. The security testing can be any type of routine, procedure, algorithm, application program, data, series of commands, instructions, etc. which can test and analyze the security of target computing device 106 and provide data about the test to security tool 102. In implementations, security tool 102 can be operable to collect and report on information from target computing device 106 and communicate those findings to server 108 and/or security server 106. In implementations, security tool 102 can be operable to collect and determine a security level for target computing device 106, and communicate the finding to server 108 and/or security server 106.

In embodiments, security tool 102 can be configured to deliver application programs that can perform various actions on target computing device 106 and provide data to security tool 102. The application programs can be configured to test the security of target computing device 106, such as a network vulnerability scanner, and provide the data about the vulnerability scan back to security tool 102. Likewise, the application programs can be configured to collect configuration information from target computing device 106, such as type and configuration of hardware installed, type of software installed, network settings (IP address, user name, password), user setting (user name, password), and the like, and configured to provide the collected configuration information to security tool 102. Security tool 102 can be operable to communicate the results of this analysis to server 108 and/or security server 104.

While several examples of commands provided by security tool 102 are described above, one skilled in the art will realize that security tool 102 can provide any type of command that can cause target computing device 106 to perform actions in order to identify weakness in the security of target computing device 106.

In embodiments, as described herein, security tool 102 can be implemented and executed on any of the computing systems of environment 100 in order to test and analyze the security of target computing device 106 and any other computing systems in communication with network 112. For example, security tool 102 can be stored on server 108 and implemented and executed on target computing device 106 or on other devices in communication with network 112. When configured as an application program, security tool 102 can be stored on any type of computer readable storage medium, such as hard drives, optical storage, system memory, and the like, of the computing systems of the environment 100.

In embodiments, security tool 102 can be configured to include security vulnerability database 114. Likewise, security vulnerability database 116 can be stored in a repository associated with any of the computing systems of the environment 100 and accessed remotely by security tool 102. The repository can be stored any type of computer readable storage medium, such as hard drives, optical storage, system memory, and the like, of the computing systems of the environment 100. While FIG. 1 illustrates a single security vulnerability database 114, one skilled in the art will realize that security vulnerability database 114 can comprise multiple databases.

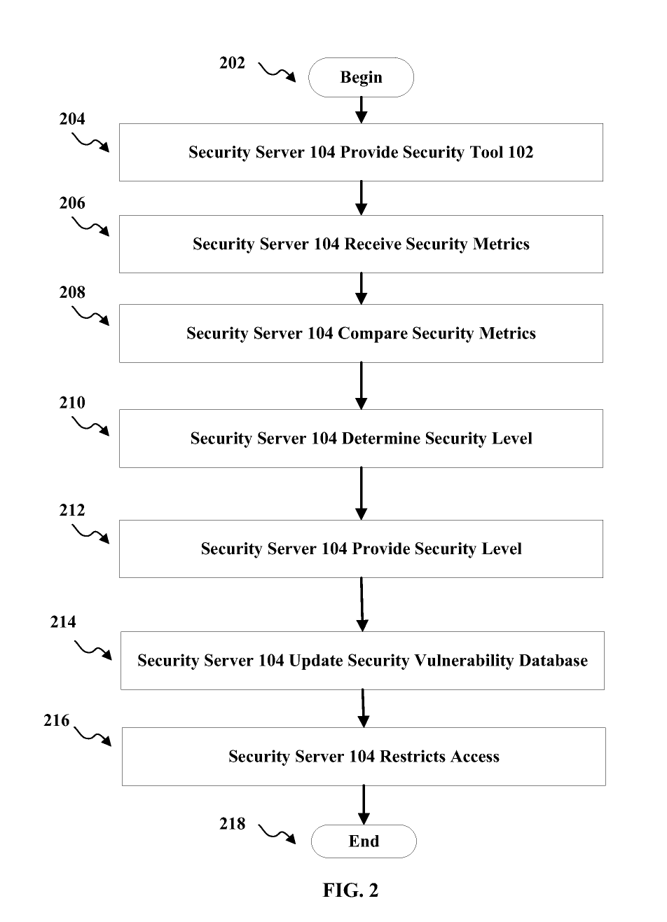

As mentioned above, security tool 102 can be configured to test and analyze a computing system. FIG. 2 is a flow diagram that illustrates an exemplary process by which security tool 102 can test and analyze the security of target computing device 106. In 202, the process can begin.

In 204, security server 104 can be operable to provide security tool 102 to server 108. For example, server 108 can be operable to function as a web server for an organization. Security tool 102 can include or be associated with security vulnerability database 114. Security tool 102 and/or security vulnerability database 116 can be updated periodically to include the latest hardware and/or software information usable by devices within environment 100. Security tool 102 can be operable to be associated with a webpage accessible by target computing device 106 through server 108. Security tool 102 can be operable to be executable by target computing device 106 or any computing device within environment 100 and operable to collect one or more security metrics of target computing device 106. The one or more security metrics can include information related to a software, a hardware, or both a software and hardware configuration of target computing device 106. For example, the information can include one or more of the following: operating system type, operating system version, operating system version update status, browser type, browser version, browser version update status, browser plug-in type, browser plug-in version, browser plug-in version update status, and combinations thereof. In implementations, the one or more security metrics can include product names and version numbers of software installed on target computing device 106.

In 206, security server 104 can be operable to receive from server 108 the one or more security metrics of target computing device 106. For example, security tool 102 on target computing device 106 can communicate the one or more security metrics to server 108 over network 112. Server 108 can then communicate the one or more security metrics to security server 104 over 110.

In 208, security server 104 can be operable to compare the one or more security metrics of target computing device 106 with security vulnerability database 114. For example, security vulnerability database 114 can include a list of hardware components, a list of software components, update and patch information for both hardware and software components that are typical of components of target computing device 106 or any computing device within environment 100. Security server 104 can then determine if features of target computing device 106 may be vulnerable to or susceptible to an attack based on vulnerable features of target computing device 106.

In 210, security server 104 can be operable to determine a security level for target computing device 106 based on comparing the one or more security metrics with security vulnerability database 114. For example, the security level can be a determined as a numerical score or a relative measure of potential vulnerability ranging from high, medium, low, to no security vulnerability. The range of security levels is just one example, and granularity of security levels can be as coarse or as fine as the organization desires. The organization can set a security level threshold level that target computing device 106 or any computing device within environment 100 must meet in order to access network resources in environment 100. The security level threshold level can be set for individual computing devices or groups of computing devices.

For example, security server 104 can be operable to compare items of the information collected from target computing device 106 with a current security vulnerability database to determine a composite security level. The composite security level can be composed of a weighed measure based on the likelihood a particular feature of target computing device 106 being exploitable. For example, since many exploits are due to out-of-date software, an out-of-date browser may be weighted higher than a current version of an operating system used by target computing device 106. Moreover, a current hardware profile of the target computing device may be weighted the lowest. The security level can be compared with a predetermined security level threshold and a determination can be made as to what level of access target computing device 106 can have to server 108 or any network resource of the organization.

In 212, security server 104 can be operable to provide the security level to server 108 and/or target computing device 106. For example, security server 104 can communicate the security level of target computing device 106 or any computing device within environment 100 that has been determined over to server 108 via network 110. Server 108 can then communicate, over network 112, the security level of target computing device 106. Security server 104 and/or server 108 can maintain the determined security level of target computing device 106 in a database.

In 214, security server 104 can be operable to update the security vulnerability database with a new security vulnerability database. For example, on a periodic basis, security server 104 can be provided with a new profile of hardware and/or software components that can be used by target computing device 106 or any other computing device within environment 100 along with any potential vulnerability associated therewith. Server 104 can then be operable to compare the one or more security metrics with the updated security vulnerability database and determine a new security level for target computing device 106.

In 216, security server 104 can be operable to restrict access to server 108, or any network resources of organization, if the security level does meet or is less than the predetermined security level threshold by redirecting target computing device 106 to another web page. Additionally or alternatively, security server 104 can be operable to restrict access to a particular web page or server 108, or any network resources of organization, if the security level does not meet or is less than the predetermined security level threshold by providing an overlay on a screen of target computing device 106 such that the user of target computing device 106 cannot a particular web page or access server 108, or any network resources of organization. For example, security server 104 can communicate an instruction to server 108, over network 110, indicating that target computing device 106 has a security level that does not meet or is below the threshold and should be restricted as to which content or resources the user of target computing device 106 is able to access.

In 218, the process can end, return to any point, or repeat.

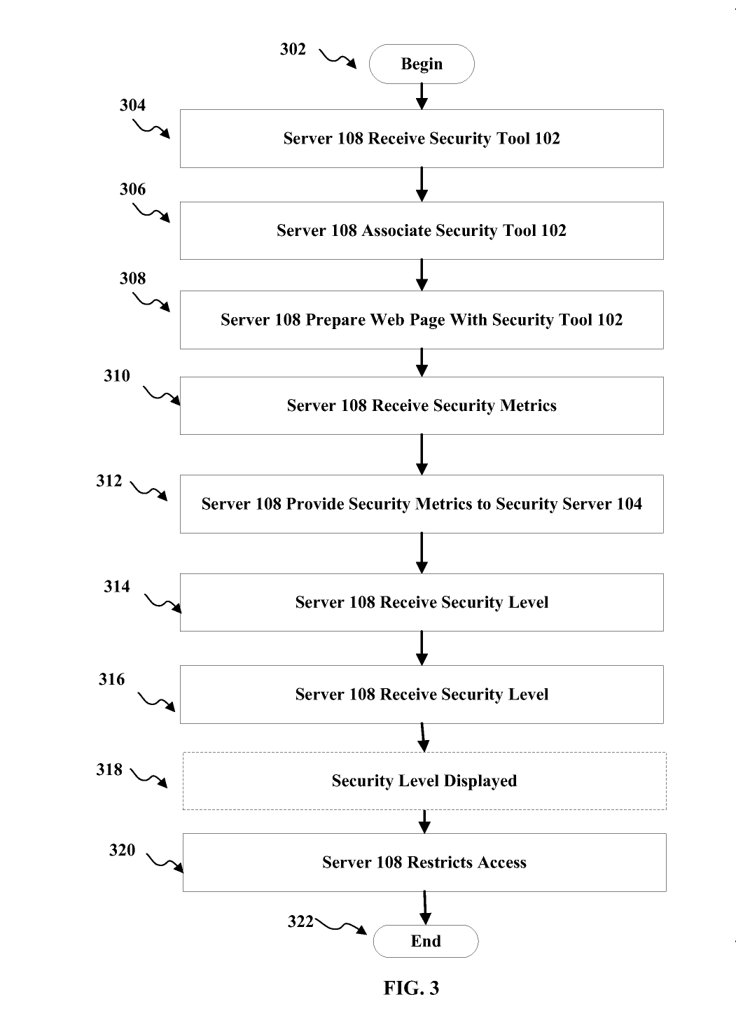

FIG. 3 is a flow diagram that illustrates an exemplary process by which security tool 102 can test and analyze the security of target computing device 106. In 302, the process can begin.

In 304, server 108 can be operable to receive security tool 102 from security server 104 over network 110. Security tool 102 can be operable to be executable by target computing device 106 and operable to collect one or more security metrics of target computing device 106.

Security tool 102 can be communicated to target computing device 106 in order to test the security of target computing device 106. Security tool 102 can be operable to scan target computing device 106 to identify one or more potential security vulnerabilities that may exist due to a hardware and/or software configuration of target computing device 106. Security testing and/or collecting performed by security tool 102 can be any type of routine, procedure, algorithm, application program, data, series of commands, instructions, etc. which can collect, test, and analyze the security of target computing device 106 and provide data about the test to server 108 and/or security server 104 through networks 110 and/or 112.

In 306, server 108 can be operable to associate security tool 102 with one or more webpages that are accessible by target computing device 106, or any other computing device within environment 100 where the security of that device is desired to be determined. For example, security tool 102 can be embedded in the one or more webpages by server 108 in such a manner that a user of target computing device 106, or any user of computing devices within environment 100, is unaware of the presence of security tool 102. Security tool 102 can be embedded in such a manner that the process of opening the web page having the embedded security tool 102 activates without requiring steps from the user. The one or more webpages chosen to contain security tool 102 can include those webpages frequently visited by the users of devices in environment 100. Server 108 can be operable to collect and maintain metrics related to browser history of the users in environment 100 in order to predict which webpage to associate security tool 102.

For example, server 108 can be operable to associate, for example, by embedding the security tool into a webpage provided by the intranet server, wherein the webpage is accessible by target computing device 106 and activated by target computing device 106 if the webpage is accessed by target computing device 106. For example, the one or more security metrics includes information comprises one or more of the following: operating system type, operating system version, operating system version update status, browser type, browser version, browser version update status, browser plug-in type, browser plug-in version, browser plug-in version update status, and combinations thereof.

In 308, server 108 can be operable to provide the webpage with the security tool 102 to target computing device 106. For example, server 108 can be operable to collect and maintain metrics related to frequently accessed webpages viewed by target computing device 106. Security tool 102 can be associated with the one or more webpages that target computing device 106 may likely request. This can be done before or after a particular webpage is requested by target computing device 106.

In 310, server 108 can be operable to receive the one or more security metrics of target computing device 106. Security tool 102 can be operable to collect and/or analyzed the one or more security metrics on target computing device 106 and communicate this information over network 112. Security tool 102 can collect, analyze, and communicate the one or more security metrics without user awareness and interaction.

In 312, server 108 can be operable to provide the one or more security metrics to security server 104 to determine a security level for target computing device 106. Once server 108 receives the one or more security metrics from target computing device 106 over network 112, server 108 can then communicate this information, over network 110, to security server 104.

In 314, server 108 can be operable to receive the security level from security server 104. Once the security level is received, server 108 can be operable to communicate the security level to target computing device 106.

In 316, server 108 can be operable to receive, from security server 104, a security level for target computing device 106. Once received, server 108 can be operable to provide access ability to the target computing device 106 based on the security level.

In 318, security tool 102 optionally can be operable display the security level on the screen of target computing device 106 to inform the user of the security level of target computing device 106.

In 320, server 108 can be operable to restrict access to resources provided by the web server if the security level does not meet or is less than the predetermined security level threshold by redirecting target computing device 106 to another web page. Additionally or alternatively, server 108 can be operable to restrict access to a particular web page or resources provided by the web server if the security level does not meet or is less than the predetermined security level threshold by providing an overlay on a screen of target computing device 106 such that the user of target computing device 106 cannot access the web page or resources.

In 322, the process can end, return to any point or repeat.

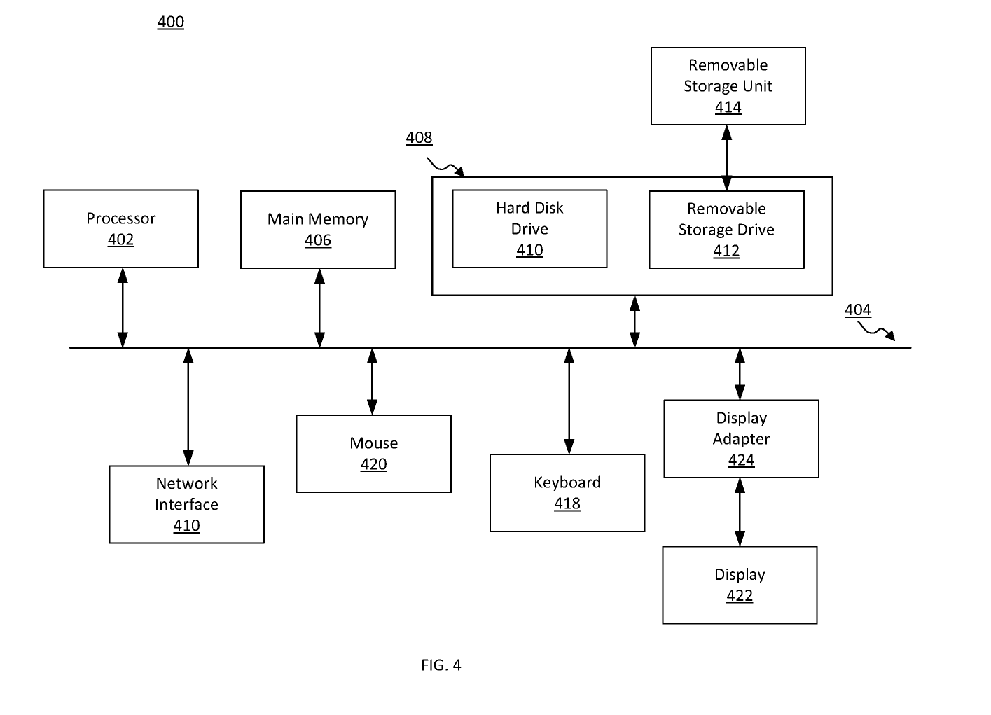

FIG. 4 illustrates an exemplary block diagram of a computing system 400 which can be implemented as security server 104 and/or server 108 according to various embodiments. In embodiments, security tool 102 can be stored on computing system 400 and operable to be executed on target computing device 106 in order to perform the process described above. Likewise, security tool 102 can be stored and executed remotely and can be configured to communicate with computing system 400, server 108, and/or target computing device 106 over networks 110 and/or 112 in order to perform the process described above. While FIG. 4 illustrates various components of computing system 400, one skilled in the art will realize that existing components can be removed or additional components can be added.

As shown in FIG. 4, computing system 400 can include one or more processors, such as processor 402 that provide an execution platform for embodiments of security tool 102. Commands and data from processor 402 are communicated over communication bus 404. Computing system 400 can also include main memory 406, for example, one or more computer readable storage media such as a Random Access Memory (RAM), where security tool 102, and/or other application programs, such as an operating system (OS) can be executed during runtime, and can include secondary memory 408. Secondary memory 408 can include, for example, one or more computer readable storage media or devices such as hard disk drive 410 and/or removable storage drive 412, representing a floppy diskette drive, a magnetic tape drive, a compact disk drive, etc., where a copy of an application program embodiment for security tool 102 can be stored. Removable storage drive 412 reads from and/or writes to removable storage unit 414 in a well-known manner. The computing system 400 can also include a network interface 416 in order to connect with the one or more networks 110.

In embodiments, a user can interface with computing system 400 and operate security tool 102 with keyboard 418, mouse 420, and display 422. To provide information from computing system 400 and data from security tool 102, the computing system 400 can include display adapter 424. Display adapter 424 can interface with communication bus 404 and display 422. Display adapter 424 can receive display data from processor 402 and convert the display data into display commands for display 422.

Certain embodiments may be performed as a computer application or program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include computer readable storage devices and media, and signals, in compressed or uncompressed form. Exemplary computer readable storage devices and media include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present teachings can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the teachings has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. Those skilled in the art will recognize that these and other variations are possible within the spirit and scope as defined in the following claims and their equivalents.

What is claimed is:

1. A method for security testing, comprising:
providing, to a server via a network, a security tool operable to be embedded in a web page provided by the server and accessible by a target computing device through the server, wherein the security tool is executed by the target computing device to collect one or more security metrics of the target computing device;
receiving, from the security tool, the one or more security metrics of the target computing device;
comparing the one or more security metrics with a security vulnerability database; and
determining a security level for the target computing device based on comparing the one or more security metrics with the security vulnerability database.

2. The method of claim 1, wherein the security tool comprises a scripting language software component that can be placed anywhere on the web page without requiring other modification of the web page.

3. The method of claim 1, the method further comprising:
providing the security level to the server.

4. The method of claim 1, wherein the server includes a web server.

5. The method of claim 1, the method further comprising:
updating the security vulnerability database;
comparing the one or more security metrics with the updated security vulnerability database; and
determining a new security level for the target computing device based on comparing the one or more security metrics with the updated security vulnerability database.

6. The method of claim 1, wherein the one or more security metrics comprise information related to a software, a hardware, or both a software and hardware configuration of the target computer device.

7. The method of claim 1, further comprising controlling access to the web page based on the security tool.

8. The method of claim 1, further comprising controlling access to the web page or other web pages associated with a website based on the security level of the target computing device.

9. The method of claim 8, wherein the controlling access further comprises embedding the security tool in one or more web pages associated with the website.

10. The method of claim 8, wherein the controlling access further comprises embedding the security tool on a login web page associated with the website and controlling access to other web pages associated with the website based on the security tool.

11. The method of claim 1, wherein output of the security tool is integrated with an access control and permission system of a web site associated with the webpage to control access to the web page or other web pages associated with the web site.

12. The method of claim 1, further comprising dynamically measuring a security level of the target computing device to control access to resources.

13. The method of claim 12, wherein the resources are selected from the following: a web site associated with the web page, an embeddable web component of the web page, a mail server, a mail client, or combinations thereof.

14. The method of claim 6, wherein the information comprises one or more of the following: operating system type, operating system version, operating system version update status, browser type, browser version, browser version update status, browser plug-in type, browser plug-in version, browser plug-in version update status, and combinations thereof.

15. The method of claim 6, the method further comprising:
comparing each item of the information with a current security database for each item of the information on the target computing device;
determining a security level for the target computer device;
comparing the security level with a predetermined security level threshold; and
determining access ability of the target computing device to the server.

16. The method of claim 15, the method further comprising:
restricting access to the server if the security level does not meet the predetermined security level threshold by redirecting the target computing device to another web page.

17. The method of claim 15, the method further comprising:
restricting access to the server if the security level does not meet the predetermined security level threshold by providing an overlay on a screen of the target computing device such that the user of the target computing device cannot access the web page.

18. A method for security testing a target computing system using a security tool from a security server, comprising:
receiving, at a web server from the security server via a network, the security tool operable to be executable by the target computing device and operable to collect one or more security metrics of the target computer device;
embedding the security tool into a web page that is operable to be accessible by the target computing device;
providing the web page with the security tool to the target computing device; and
controlling access to the web page based on a security level as determined based on the one or more security metrics.

19. The method of claim 18, the method further comprising:
receiving the security level from the security server; and
providing the security level to the target computing device.

20. The method of claim 18, wherein the security tool is operable to collect one or more security metrics from the target computing device, wherein the one or more security metrics comprise information related to a software, a hardware, or both a software and hardware configuration of the target computing device.

21. The method of claim 18, wherein the embedded security tool is provided by the web server and which is accessible by the target computing device and activated if the web page is accessed by the target computing device.

22. The method of claim 18, wherein the one or more security metrics includes information comprises one or more of the following: operating system type, operating system version, operating system version update status, browser type, browser version, browser version update status, browser plug-in type, browser plug-in version, browser plug-in version update status, and combinations thereof.

23. The method of claim 18, the method further comprising:
receiving, from the security server, the security level for the target computing device;
providing access ability of the target computing device based on the security level.

24. The method of claim 23, the method further comprising:
restricting access to resources provided by the web server if the security level does not meet the predetermined security level threshold by redirecting the target computing device to another web page.

25. The method of claim 23, the method further comprising:
restricting access to resources provided by the web server if the security level does not meet the predetermined security level threshold by providing an overlay on a screen of the target computing device such that the user of the target computing device cannot access the resources.

26. The method of claim 18, the method further comprising:
determining if the security tool is installed on the target computing device; and
restricting access to the resources provided by the web server if the security tool is not found to be on the target computing device

27. A device comprising:
one or more processors; and
a computer readable medium comprising instructions that cause the one or more processors to perform a method comprising:
providing, to a server via a network, a security tool operable to be embedded in a web page accessible by a target computing device through the server, wherein security tool is operable to be executable by the target computing device and operable to collect one or more security metrics of the target computing device;
receiving, from the server, the one or more security metrics of the target computing device;
comparing the one or more security metrics with a security vulnerability database;
determining a security level for the target computing device based on comparing the one or more security metrics with the security vulnerability database; and
controlling access to the web page based on the security level.

28. A device operable to provide security testing of a target computing system using a security tool from a security server, comprising:
one or more processors; and
a computer readable medium comprising instructions that cause the one or more processors to perform a method comprising:
receiving, at a web server from the security server via a network, the security tool operable to be executable by the target computing device and operable to collect one or more security metrics of the target computing device;
embedding the security tool in a web page that is operable to be accessible by the target computing device;
providing the web page with the security tool to the target computing device; and
controlling access to the web page based on a security level as determined based on the one or more security metrics.

29. A method for security testing, comprising:
providing a security tool to a target computing device associated with a web page accessible by the target computing device, wherein security tool is executed by the target computing device to collect one or more security metrics of the target computer device;
receiving the one or more security metrics of the target computing device;
comparing the one or more security metrics with a security vulnerability database;
determining a security level for the target computing device based on comparing the one or more security metrics with the security vulnerability database; and
controlling an access capability of the target computing device based on the security level.

30. The method of claim 29, wherein the security tool is embedded into a web page provided to the target computing device.
